(19) United States
(12) Patent Application Publication
(10) Pub. No.: US 2022/0351339 A1
(43) Pub. Date: Nov. 3, 2022

(54) SYSTEMS AND METHODS FOR REAL-TIME DE-HAZING IN IMAGES

(71) Applicant: Covidien LP, Mansfield, MA (US)

(72) Inventors: Xiaofang Gan, Shanghai (CN); Xiao Li, Shanghai (CN); Ruiwen Li, Shanghai (CN); Zhentao Lu, Shanghai (CN)

(21) Appl. No.: 17/760,843

(22) PCT Filed: Sep. 16, 2019
(86) PCT No.: PCT/CN2019/105983

§ 371 Date: Mar. 16, 2022

(51) Int. Cl. G06T 5/00; G06T 3/40

(52) U.S. Cl. CPC G06T 5/003; G06T 3/40; G06T 2207/10068; G06T 2207/20021

(57) ABSTRACT

Systems and methods for haze reduction in images are disclosed. An exemplary method for haze reduction includes accessing an image of an object obscured by haze where the image has an original resolution, downscaling the image to provide a downscaled image having a lower resolution than the original resolution, processing the downscaled image to generate dehazing parameters corresponding to the lower resolution, converting the dehazing parameters corresponding to the lower resolution to second dehazing parameters corresponding to the original resolution, and dehazing the image based on the second dehazing parameters corresponding to the original resolution.

### CROSS-REFERENCE TO RELATED APPLICATIONS

The present application is a U.S. National Stage Application filed under 35 U.S.C. § 371(a) claiming the benefit of and priority to International Patent Application No. PCT/CN2019/105983, filed Sep. 16, 2019, the entire disclosure of which is being incorporated by reference herein.

### FIELD

The present disclosure relates to devices, systems and methods for haze-reduction in images, and more particularly, to real-time haze-reduction in images during surgical procedures.

### BACKGROUND

Endoscopes are introduced through an incision or a natural body orifice to observe internal features of a body. Conventional endoscopes are used for visualization during endoscopic or laparoscopic surgical procedures. During such surgical procedures, it is possible for smoke to be generated when the energy surgical instrument is used, for example, to cut tissue with electrosurgical energy during the surgery. Thus, the image acquired by the endoscope may become blurry because of this smoke. The smoke may obscure features of the surgical site and delay the surgical procedure while surgeons wait for the smoke to clear. Other procedures may experience similar issues where smoke or other haze is present during the capture of an image. Accordingly, there is interest in improving imaging technology.

### SUMMARY

The present disclosure relates to devices, systems, and methods for haze reduction in images. In accordance with aspects of the present disclosure, a method for haze reduction in images includes accessing an image of an object obscured by haze where the image has an original resolution, downscaling the image to provide a downscaled image having a lower resolution than the original resolution, processing the downscaled image to generate a dehazing parameter corresponding to the lower resolution, converting the dehazing parameter corresponding to the lower resolution to a second dehazing parameter corresponding to the original resolution, and dehazing the image based on the second dehazing parameter corresponding to the original resolution.

In various embodiments of the method, the downscaling is based on image downscaling processing and the converting is based on an inverse of the image downscaling processing, where the image downscaling processing is one of: super sampling, bicubic, nearest neighbor, bell, hermite, lanczos, mitchell, or bilinear downscaling.

In various embodiments of the method, processing the downscaled image includes: estimating an atmospheric light component value for the downscaled image, determining a dark channel matrix of the downscaled image, and determining a transmission map for the downscaled image according to the atmospheric light component and the dark channel matrix.

In various embodiments of the method, converting the dehazing parameter corresponding to the lower resolution to the second dehazing parameter corresponding to the original resolution includes converting the transmission map for the downscaled image to a second transmission map for the original image.

In various embodiments of the method, dehazing the image includes: converting the image from at least one of an RGB image, a CMYK image, a CIELAB image, or a CIEXYZ image to a YUV image, performing a de-hazing operation on the YUV image to provide a Y′UV image, and converting the Y′UV image to the de-hazed image.

In various embodiments of the method, performing the de-hazing operation on the YUV image includes, for each pixel x in the YUV image: determining Y′ as

$${Y}^{′} ( x ) = \frac{Y ( x ) - A}{T\_N ( x )} ,$$

where T_N(x) is a value of the second transmission map corresponding to the pixel x, and A is the atmospheric light component value for the downscaled image.

In various embodiments of the method, determining the transmission map for the downscaled image includes determining, for each pixel x of the downscaled image:

$$T ( x ) = 1 - ω * \frac{I\_DARK ( X )}{A} ,$$

where ω is a predetermined constant, I_DARK(x) is a value of the dark channel matrix for the pixel x, and A is the atmospheric light component value.

In various embodiments of the method, estimating the atmospheric light component value for the downscaled image includes, for a block of pixels in the downscaled image: determining if a width times height for the block of pixels is greater than a predetermined threshold value; in a case where the width times height is greater than the predetermined threshold value: dividing the block of pixels into a plurality of smaller pixel areas, calculating a mean value and a standard deviation for pixel values of each of the smaller pixel areas, determining a score for each of the smaller pixel areas based on the mean value minus the standard deviation for the smaller pixel area, and identifying one of the plurality of smaller pixel areas having a highest score among the scores; and in a case that the width times height is not greater than the predetermined threshold value, estimating the atmospheric light component value as a darkest pixel in the block of pixels.

In various embodiments of the method, estimating the atmospheric light component value includes smoothing the atmospheric light component value based on an estimated atmospheric light component value for a previous dehazed image frame.

In various embodiments of the method, smoothing the atmospheric light component value includes determining the atmospheric light component value as: A=A-CUR*coef+A-PRE*(1−coef), where A-CUR is the estimated atmospheric light component value for the downscaled image, A-PRE is the estimated atmospheric light component value for a previous downscaled image, and coef is a predetermined smoothing coefficient.

In accordance with aspects of the present disclosure, a system for haze reduction in images includes an imaging device configured to capture an image of an object obscured by haze, a display device, a processor, and a memory storing instructions. The instructions, when executed by the processor, cause the system to access the image of the object obscured by haze where the image has an original resolution, downscale the image to provide a downscaled image having a lower resolution than the original resolution, process the downscaled image to generate a dehazing parameter corresponding to the lower resolution, convert the dehazing parameter corresponding to the lower resolution to a second dehazing parameter corresponding to the original resolution, dehaze the image based on the second dehazing parameter corresponding to the original resolution, and display the de-hazed image on the display device.

In various embodiments of the system, the downscaling is based on image downscaling processing and the converting is based on an inverse of the image downscaling processing, where the image downscaling processing is one of: super sampling, bicubic, nearest neighbor, bell, hermite, lanczos, mitchell, or bilinear downscaling.

In various embodiments of the system, in processing the downscaled image, the instructions, when executed by the processor, cause the system to: estimate an atmospheric light component value for the downscaled image, determine a dark channel matrix of the downscaled image, and determine a transmission map for the downscaled image according to the atmospheric light component and the dark channel matrix.

In various embodiments of the system, in converting the dehazing parameter corresponding to the lower resolution to the second dehazing parameter corresponding to the original resolution, the instructions, when executed by the processor, cause the system to convert the transmission map for the downscaled image to a second transmission map for the original image.

In various embodiments of the system, in dehazing the image, the instructions, when executed by the processor, cause the system to: convert the image from at least one of an RGB image, a CMYK image, a CIELAB image, or a CIEXYZ image to a YUV image, perform a de-hazing operation on the YUV image to provide a Y′UV image, and convert the Y′UV image to the de-hazed image.

In various embodiments of the system, in performing the de-hazing operation on the YUV image, the instructions, when executed by the processor, cause the system to: determine Y′ as

$${Y}^{′} ( x ) = \frac{Y ( x ) - A}{T\_N ( x )} ,$$

where T_N(x) is a value of the second transmission map corresponding to the pixel x, and A is the atmospheric light component value for the downscaled image.

In various embodiments of the system, in determining the transmission map for the downscaled image, the instructions, when executed by the processor, cause the system to determine, for each pixel x of the downscaled image:

$$T ( x ) = 1 - ω * \frac{I\_DARK ( X )}{A} ,$$

where ω is a predetermined constant, I_DARK(x) is a value of the dark channel matrix for the pixel x, and A is the atmospheric light component value.

In various embodiments of the system, in estimating the atmospheric light component value for the downscaled image, the instructions, when executed by the processor, cause the system to, for a block of pixels in the downscaled image: determine if a width times height for the block of pixels is greater than a predetermined threshold value; in a case where the width times height is greater than the predetermined threshold value: divide the block of pixels into a plurality of smaller pixel areas, calculate a mean value and a standard deviation for pixel values of each of the smaller pixel areas, determine a score for each of the smaller pixel areas based on the mean value minus the standard deviation for the smaller pixel area, and identify one of the plurality of smaller pixel areas having a highest score among the scores; and in a case that the width times height is not greater than the predetermined threshold value, estimate the atmospheric light component value as a darkest pixel in the block of pixels.

In various embodiments of the system, in estimating the atmospheric light component value, the instructions, when executed by the processor, cause the system to smooth the atmospheric light component value based on an estimated atmospheric light component value for a previous dehazed image frame.

In various embodiments of the system, in smoothing the atmospheric light component value, the instructions, when executed by the processor, cause the system to determine the atmospheric light component value as: A=A-CUR*coef +A-PRE*(1−coef), where A-CUR is the estimated atmospheric light component value for the downscaled image, A-PRE is the estimated atmospheric light component value for a previous downscaled image, and coef is a predetermined smoothing coefficient.

Further details and aspects of various embodiments of the present disclosure are described in more detail below with reference to the appended figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the present disclosure are described herein with reference to the accompanying drawings, wherein:

FIG. 1 is a diagram of an exemplary visualization or endoscope system in accordance with the present disclosure;

FIG. 2 is a schematic configuration of the visualization or endoscope system of FIG. 1;

FIG. 3 is a diagram illustrating another schematic configuration of an optical system of the system of FIG. 1;

FIG. 4 is a schematic configuration of the visualization or endoscope system in accordance with an embodiment of the present disclosure;

FIG. 5 is a flowchart of a method for smoke reduction in accordance with the disclosure;

FIG. 6 is an exemplary input image including an area of pixels in accordance with the present disclosure;

FIG. 7 is a flowchart of a method for estimating atmospheric light component value in accordance with the disclosure;

FIG. 8 is a flowchart of a method for performing de-hazing in accordance with the disclosure;

FIG. 9 is a flowchart of a method for performing low pass filtering on the atmospheric light component value in accordance with the disclosure;

FIG. 10 is an exemplary image with haze in accordance with the present disclosure;

FIG. 11 is an exemplary de-hazed image with atmospheric light calculated in accordance with the present disclosure; and

FIG. 12 is a flowchart of a method for performing real-time haze reduction in accordance with the disclosure.

Further details and aspects of exemplary embodiments of the disclosure are described in more detail below with reference to the appended figures. Any of the above aspects and embodiments of the disclosure may be combined without departing from the scope of the disclosure.

### DETAILED DESCRIPTION OF EMBODIMENTS

Embodiments of the presently disclosed devices, systems, and methods of treatment are described in detail with reference to the drawings, in which like reference numerals designate identical or corresponding elements in each of the several views. As used herein, the term “distal” refers to that portion of a structure that is farther from a user, while the term “proximal” refers to that portion of a structure that is closer to the user. The term “clinician” refers to a doctor, nurse, or other care provider and may include support personnel. The term “haze” refers to haze, smoke, fog, or other airborne particulate matter.

The present disclosure is applicable where images of a surgical site are captured. Endoscope systems are provided as an example, but it will be understood that such description is exemplary and does not limit the scope and applicability of the present disclosure to other systems and procedures.

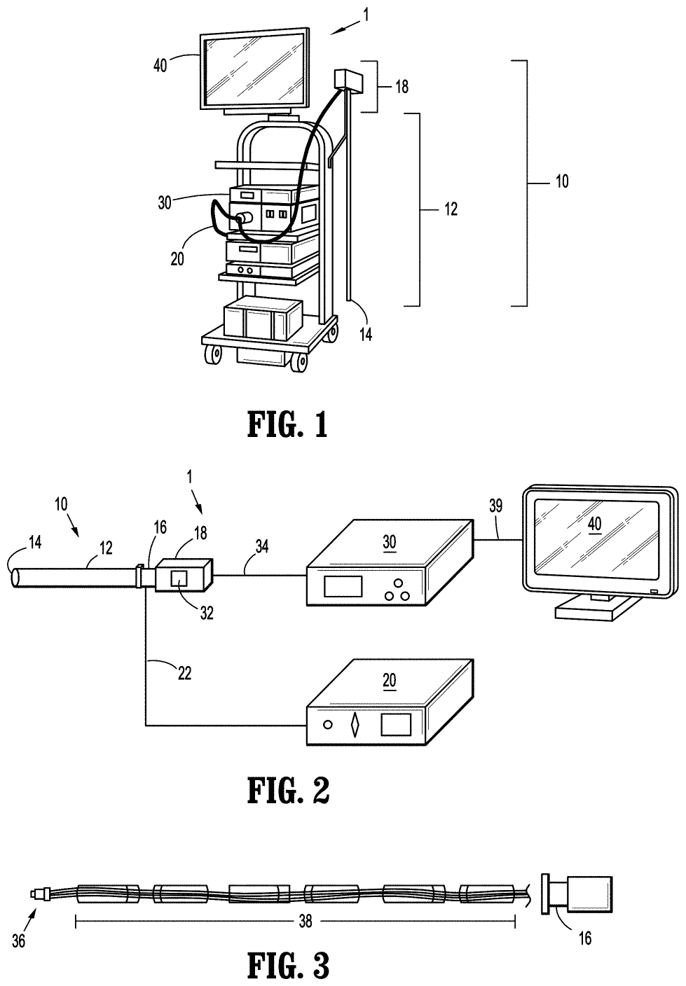

Referring initially to FIGS. 1-3, an endoscope system 1, in accordance with the present disclosure, includes an endoscope 10, a light source 20, a video system 30, and a display device 40. With continued reference to FIG. 1, the light source 20, such as an LED/Xenon light source, is connected to the endoscope 10 via a fiber guide 22 that is operatively coupled to the light source 20 and to an endocoupler 16 disposed on, or adjacent to, a handle 18 of the endoscope 10. The fiber guide 22 includes, for example, a fiber optic cable which extends through the elongated body 12 of the endoscope 10 and terminates at a distal end 14 of the endoscope 10. Accordingly, light is transmitted from the light source 20, through the fiber guide 22, and emitted out the distal end 14 of the endoscope 10 toward a targeted internal feature, such as tissue or an organ, of a body of a patient. As the light transmission pathway in such a configuration is relatively long, for example, the fiber guide 22 may be about 1.0 m to about 1.5 m in length, only about 15% (or less) of the light flux emitted from the light source 20 is outputted from the distal end 14 of the endoscope 10.

With reference to FIG. 2 and FIG. 3, the video system 30 is operatively connected to an image sensor 32 mounted to, or disposed within, the handle 18 of the endoscope 10 via a data cable 34. An objective lens 36 is disposed at the distal end 14 of the elongated body 12 of the endoscope 10 and a series of spaced-apart, relay lenses 38, such as rod lenses, are positioned along the length of the elongated body 12 between the objective lens 36 and the image sensor 32. Images captured by the objective lens 36 are forwarded through the elongated body 12 of the endoscope 10 via the relay lenses 38 to the image sensor 32, which are then communicated to the video system 30 for processing and output to the display device 40 via cable 39. The image sensor 32 is located within, or mounted to, the handle 18 of the endoscope 10, which can be up to about 30 cm away from the distal end 14 of the endoscope 10.

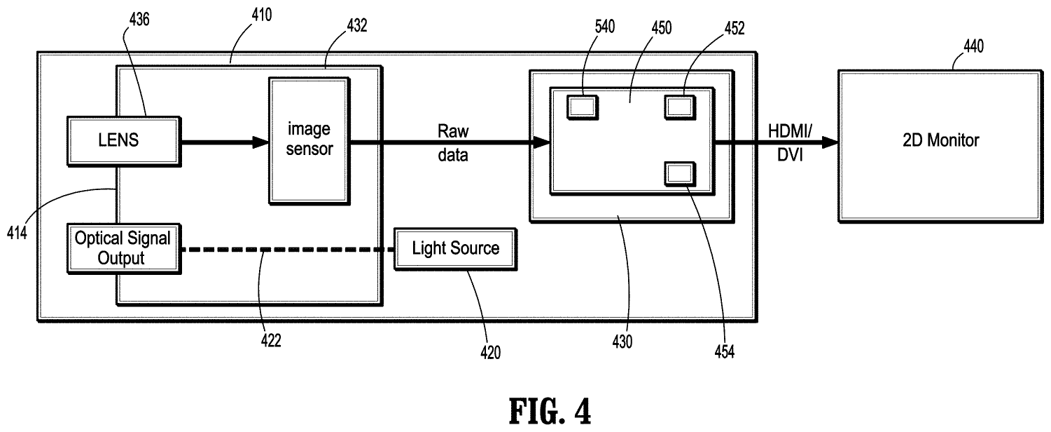

With reference to FIGS. 4-9, the flow diagrams include various blocks described in an ordered sequence. However, those skilled in the art will appreciate that one or more blocks of the flow diagram may be performed in a different order, repeated, and/or omitted without departing from the scope of the present disclosure. The below description of the flow diagram refers to various actions or tasks performed by one or more video system 30, but those skilled in the art will appreciate that the video system 30 is exemplary. In various embodiments, the disclosed operations can be performed by another component, device, or system. In various embodiments, the video system 30 or other component/device performs the actions or tasks via one or more software applications executing on a processor. In various embodiments, at least some of the operations can be implemented by firmware, programmable logic devices, and/or hardware circuitry. Other implementations are contemplated to be within the scope of the present disclosure.

Referring to FIG. 4, there is shown a schematic configuration of a system, which may be the endoscope system of FIG. 1 or may be a different type of system (e.g., visualization system, etc.). The system, in accordance with the present disclosure, includes an imaging device 410, a light source 420, a video system 430, and a display device 440. The light source 420 is configured to provide light to a surgical site through the imaging device 410 via the fiber guide 422. The distal end 414 of the imaging device 410 includes an objective lens 436 for capturing the image at the surgical site. The objective lens 436 forwards the image to the image sensor 432. The image is then communicated to the video system 430 for processing. The video system 430 includes an imaging device controller 450 for controlling the endoscope and processing the images. The imaging device controller 450 includes processor 452 connected to a computer-readable storage medium or a memory 454 which may be a volatile type memory, such as RAM, or a non-volatile type memory, such as flash media, disk media, or other types of memory. In various embodiments, the processor 452 may be another type of processor such as, without limitation, a digital signal processor, a microprocessor, an ASIC, a graphics processing unit (GPU), field-programmable gate array (FPGA), or a central processing unit (CPU).

In various embodiments, the memory 454 can be random access memory, read-only memory, magnetic disk memory, solid state memory, optical disc memory, and/or another type of memory. In various embodiments, the memory 454 can be separate from the imaging device controller 450 and can communicate with the processor 452 through communication buses of a circuit board and/or through communication cables such as serial ATA cables or other types of cables. The memory 454 includes computer-readable instructions that are executable by the processor 452 to operate the imaging device controller 450. In various embodiments, the imaging device controller 450 may include a network interface 540 to communicate with other computers or a server.

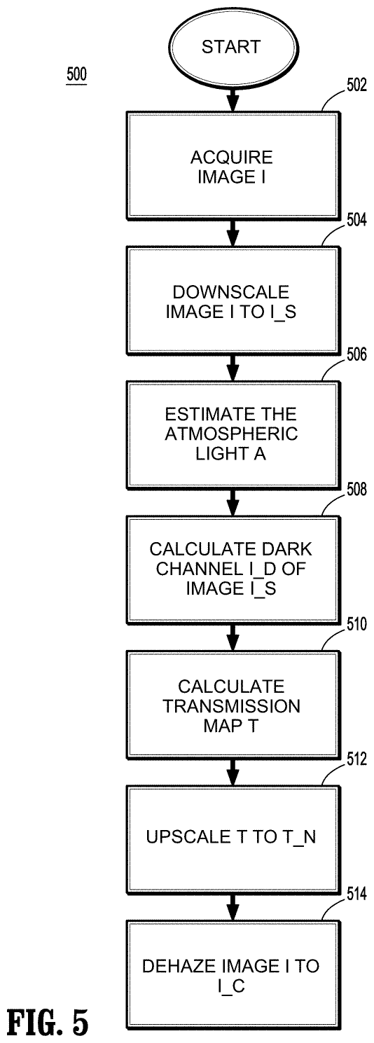

Referring now to FIG. 5, there is shown an operation for smoke reduction in images. In various embodiments, the operation of FIG. 5 can be performed by an endoscope system 1 described above herein. In various embodiments, the operation of FIG. 5 can be performed by another type of system and/or during another type of procedure. The following description will refer to an endoscope system, but it will be understood that such description is exemplary and does not limit the scope and applicability of the present disclosure to other systems and procedures. The following description will refer to an RGB (Red, Green, Blue) image or RGB color model, but it will be understood that such description is exemplary and does not limit the scope and applicability of the present disclosure to other types of images or color models. Certain aspects of the dehazing operation are described in Kaiming He et al., “Single Image Haze Removal Using Dark Channel Prior,” IEEE Transactions On Pattern Analysis And Machine Intelligence, Vol. 33, No. 12, December 2011, the entire contents of which are hereby incorporated by reference herein.

Initially, at step 502, an image of a surgical site is captured via the objective lens 36 and forwarded to the image sensor 32 of endoscope system 1. The term “image” as used herein may include still images or moving images (for example, video). In various embodiments, the captured image is communicated to the video system 30 for processing. For example, during an endoscopic procedure, a surgeon may cut tissue with an electrosurgical instrument. During this cutting, smoke may be generated. When the image is captured, it may include the smoke. Smoke is generally a turbid medium (such as particles, water droplets) in the atmosphere. The irradiance received by the objective lens 36 from the scene point is attenuated by the line of sight. This incoming light is mixed with ambient light (air light) reflected into the line of sight by atmospheric particles such as smoke. This smoke degrades the image, making it lose contrast and color fidelity. Details of exemplary input images including an area of pixels will be described in more detail later herein. The image sensor 32 may capture raw data. The format of the raw data may be RGGB, RGBG, GRGB, or BGGR. The video system 30 may convert the raw data to RGB using a demosaicing algorithm. A demosaicing algorithm is a digital image process used to reconstruct a full color image from the incomplete color samples output from an image sensor overlaid with a color filter array (CFA). It is also known as CFA interpolation or color reconstruction. The RGB image may be further converted by the video system 30 to another color model, such as CMYK, CIELAB, or CIEXYZ.

At step 504, the video system 30 downscales the image. For example, the endoscope system 1 may support 1080P at a frame rate of 60fps (the resolution of 1080P is 1920×1080 pixels), and 4 k at a frame rate of 60 fps (the resolution of 4K is 3840×2160 pixels). To reduce the computation complexity, the image may be downscaled. For example, the endoscope system 1 acquires an image at a resolution of 1080P (1920×1080 pixels). By downscaling the image to a downscaled image with resolution 192×108 pixels, the computation complexity of calculating de-hazing parameters for the downscaled image, such as estimated atmospheric light component, the dark channel matrix, and the transmission map for the downscaled image, will be approximately 1% of the computation complexity of calculating estimated atmospheric light component, the dark channel matrix, and the transmission map for the original image. In various embodiments, the downscaling may be performed by various techniques, such as super-sampling, bicubic, nearest neighbor, bell, hermite, lanczos, mitchell, or bilinear downscaling.

For example, super-sampling is a spatial anti-aliasing method. Aliasing may occur because, unlike real-world objects which have continuous smooth curves and lines, displays typically show the viewer a large number of small squares. These pixels all have the same size, and each one has a single color (determined by the intensities of the RGB channels). Color samples are taken at several instances inside a pixel area, and an average color value is calculated. This is achieved by rendering the image at a much higher resolution than the one being displayed, then shrinking it to the desired size, using the extra pixels for calculation. The result is a downscaled image with smoother transitions from one line of pixels to another along the edges of objects.

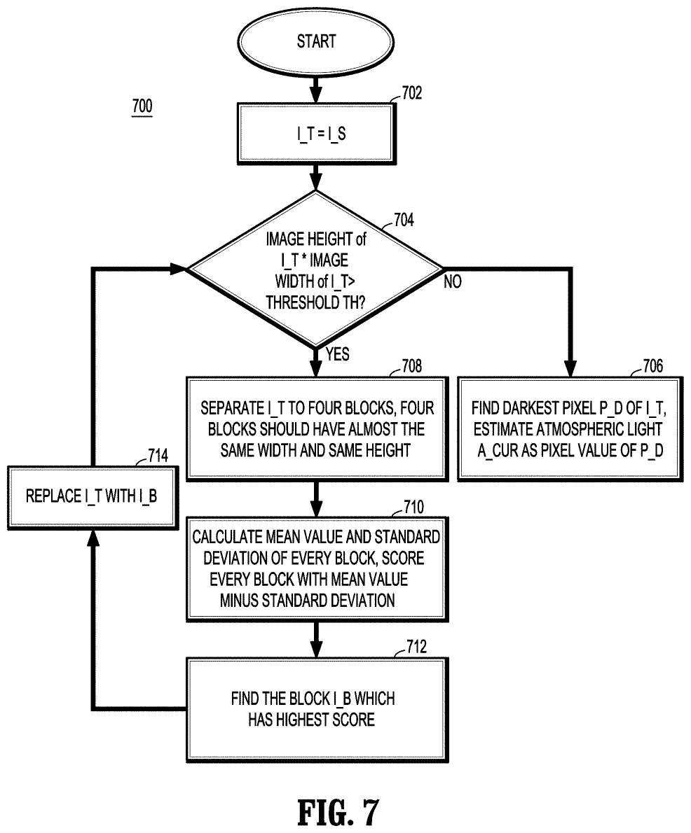

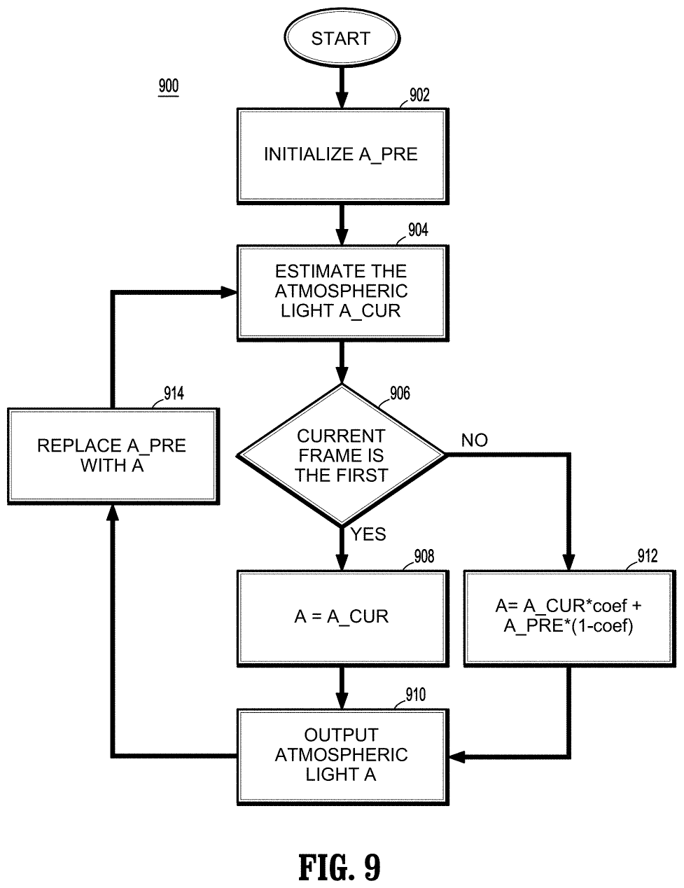

At step 506, the video system 30 estimates an atmospheric light component value for the downscaled image. The estimated atmospheric light component for the downscaled image will be denoted herein as “A.” Details of exemplary methods for estimating atmospheric light component values will be described in more detail later herein in connection with FIGS. 7 and 9.

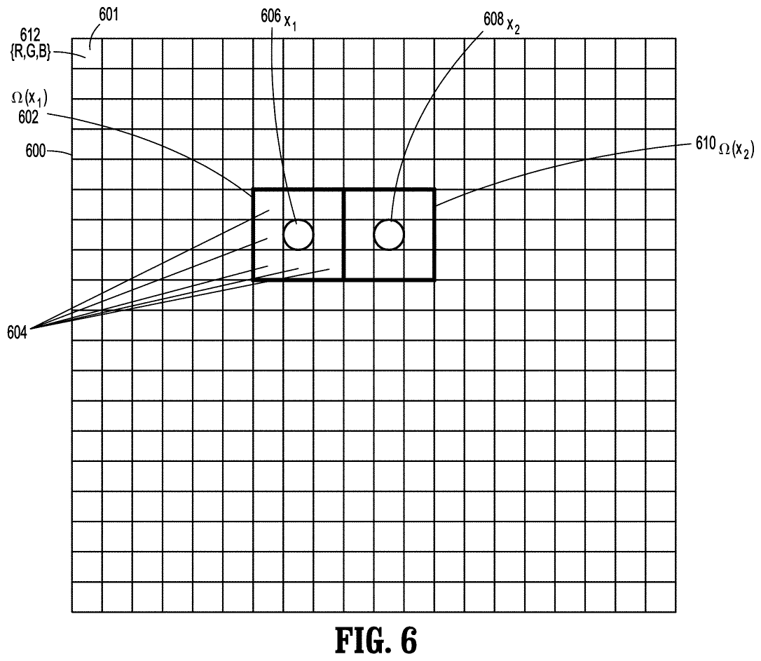

At step 508, the video system 30 determines a dark channel matrix for the image 600 (FIG. 6). As used herein, the phrase “dark channel” of a pixel refers to the lowest color component intensity value among all pixels of a patch Ω(x) 602 (FIG. 6) centered at the particular pixel x. The term “dark channel matrix” of an image, as used herein, refers to a matrix of the dark channel of every pixel of the image. The dark channel of a pixel x will be denoted as I_DARK(x). In various embodiments, the video system 30 calculates the dark channel of a pixel as follows:

I_DARK(x)=min(min(I^{c}(y))), for all c∈{r,g,b}y∈Ω(x)

where y denotes a pixel of the patch Ω(x), c denotes a color component, and I^{c}(y) denotes the intensity value of the color component c of pixel y. Thus, the dark channel of a pixel is the outcome of two minimum operations across two variables c and y, which together determine the lowest color component intensity value among all pixels of a patch centered at pixel x. In various embodiments, the video system 30 can calculate the dark channel of a pixel by acquiring the lowest color component intensity value for every pixel in the patch and then finding the minimum value among all of those values. For cases where the center pixel of the patch is at or near the edge of the image, only the part of the patch within the image is used.

At step 510, the video system 30 determines what is referred to herein as a transmission map T for the downscaled image. The transmission map T has the same number of pixels as the downscaled image. The transmission map T is determined based on the dark channel matrix and the atmospheric light component value, which were determined in steps 508 and 506, respectively. The transmission map includes a transmission component T(x) for each pixel x. In various embodiments, the transmission component can be determined as follows:

$$T ( x ) = 1 - ω * \frac{I\_DARK ( X )}{A} ,$$

where ω is a parameter having a value between 0 and 1, such as 0.85. In practice, even in clear images, there are some particles. Thus, some haze exists when distant objects are observed. The presence of haze is a cue to human perception of depth. If all haze is removed, the perception of depth may be lost. Therefore, to retain some haze, the parameter ω(0<ω<=1) is introduced. In various embodiments, the value of ω can vary based on the particular application. Thus, the transmission map for the downscaled image is equal to, for each pixel of the downscaled image, 1 minus ω times the dark channel of the pixel (I-DARK(x)) divided by the atmospheric light component A of the downscaled image.

At step 512, the video system 30 “upscales” the transmission map for the lower resolution downscaled image to a transmission map for the original image by creating an upscaled transmission map. In various embodiments, the upscaling may be performed by the inverse of the downscaling that was used in step 504, such as the inverse of super sampling, bicubic, nearest neighbor, bell, hermite, lanczos, mitchell, or bilinear downscaling. In accordance with aspects of the disclosure, the operation at step 512 involves applying an upscaling technique that is typically applied to image content, to dehazing parameters instead.

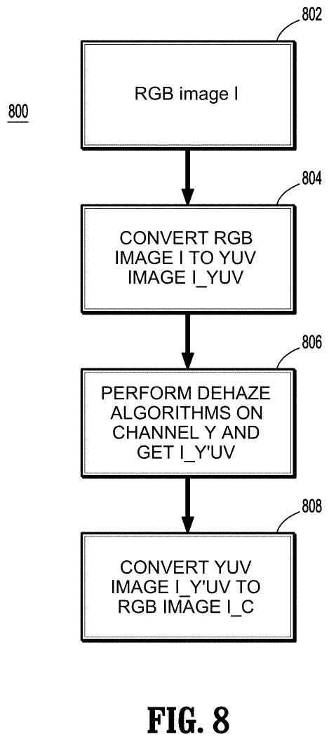

At step 514, the video system 30 de-hazes the image based on the upscaled transmission map. One way to perform the de-hazing operation will be described in detail below in connection with FIG. 8.

Referring now to FIG. 6, there is shown an exemplary pixel representation of a downscaled image, such as a downscaled image from step 504 of FIG. 5. In various embodiments, the downscaled image may or may not have been processed during the capture process or after the capture process. In various embodiments, an image 600 includes a number of pixels and the dimensions of the image 600 are often represented as the number of pixels in an X by Y format, such as 500 x 500 pixels, for example. In accordance with aspects of the present disclosure, and as explained in more detail later herein, each pixel of the image 600 may be processed based on a pixel area 602, 610, centered at that pixel, which will also be referred to herein as a patch. In various embodiments, each patch/pixel area of the image can have the same size. In various embodiments, different pixel areas or patches can have different sizes. Each pixel area or patch can be denoted as Ω(x), which is a pixel area/patch having a particular pixel x as its center pixel. In the illustrative example of FIG. 6, the pixel area 602 has a size of 3×3 pixels and is centered at a particular pixel x₁ 606. If an image has 18 by 18 pixels, then a patch size may be 3×3 pixels. The illustrated image size and patch size are exemplary, and other image sizes and patch sizes are contemplated to be within the scope of the present disclosure.

With continuing reference to FIG. 6, each pixel 601 in an image 600 may have combinations of color components 612, such as red, green, and blue, which are also referred to herein as color channels. I^{c}(y) is used herein to denote the intensity value of a color component c of a particular pixel y in the image 600. For a pixel 601, each of the color components 612 has an intensity value representing the brightness intensity of that color component. For example, for a 24-bit RGB image, each of the color components 612 has 8 bits, which corresponds to each color component having 256 possible intensity values.

For example, with reference to FIG. 6, for an image 600 that was downscaled in step 504, the pixel area (patch) size may be 3×3 pixels. For example, a 3×3 pixel area Ω(x₁) 602 centered at x₁ 606 may have the following intensities for the R, G, and B channels for each of the 9 pixels in the patch:

$$[ \begin{matrix}1 , 3 , 6 & 2 , 0 , 1 & 5 , 3 , 4 \\ 2 , 4 , 3 & 6 , 7 , 4 & 7 , 6 , 9 \\ 1 , 3 , 2 & 5 , 8 , 9 & 9 , 11 , 25\end{matrix} ]$$

In this example, for the top left pixel in the pixel area Ω(xi) 602, the R channel may have an intensity of 1, the G channel may have an intensity of 3, and the B channel may have an intensity of 6. Here, the R channel has the minimum intensity value (a value of 1) of the RGB channels for that pixel.

The minimum color component intensity value of each the pixels would be determined. For example, for the 3×3 pixel area Ω(x₁) 602 centered at xi the minimum color component intensity value for each of the pixels in the pixel area Ω(x₁) 602 are:

$$[ \begin{matrix}1 & 0 & 3 \\ 2 & 4 & 6 \\ 1 & 5 & 9\end{matrix} ]$$

Thus, the dark channel of the pixel xi would have an intensity value of 0 for this exemplary 3×3 pixel area Ω(x) 602 centered at x₁.

Referring now to FIG. 7, there is shown an exemplary method for estimating atmospheric light component value estimated in step 506 of FIG. 5. Generally, the operation determines the estimated atmospheric light component as a darkest pixel in a haze filled area of the downscaled image through an iterative process in which each iteration operates on a block of pixels denoted as I_T.

At step 702, the operation initializes the first iteration by setting the block I_T to the entire downscaled image I_S. At step 704, the video system 30 compares the width times the height of the block of pixels I_T to a predetermined threshold TH. For example, threshold TH may be 160. If the width times the height of the downscaled image is not greater than the threshold TH, then at step 706, the video system 30 determines the estimated atmospheric light component as a darkest pixel of the block of pixels I_T.

If the width times the height of the downscaled image is greater than the threshold TH, then at step 708, the video system 30 separates the block of pixels I_T into a plurality of smaller pixel areas of the same size or about the same size. For example, the video system 30 may separate the block of pixels I_T into four smaller pixel areas (or blocks) of the same size or about the same size. In various embodiments, the number of smaller pixel areas need not be four, and another number of smaller pixel areas can be used.

At step 710, the video system 30 determines a mean value and a standard deviation of the pixel values in each smaller pixel area, and determines a score for each smaller pixel area based on the mean value minus the standard deviation. In various embodiments, the video system 30 may identify the heavy smoke area in the block of pixels I_T based on the mean value and the standard deviation for each of the smaller pixel areas. For example, a heavy smoke area may have a high brightness and a low standard deviation. In various embodiments, another metric may be used to identify the smaller pixel area having the heaviest smoke within the block of pixels I_T.

At step 712, the video system 30 identifies the smaller pixel area I_B that has the highest score.

At step 714, the video system 30 prepares for the next iteration by setting the block of pixels I_T to the smaller pixel area I_B that has the highest score.. After step 714, the operation proceeds to step 704 for the next iteration. Accordingly, the operation of FIG. 7 gradually hones in on the area of the downscaled image having the heaviest smoke until the size of the block of pixels I_T is smaller than a threshold. Then, the operation concludes, at step 706, by determining the atmospheric light component of the downscaled image as the value of the darkest pixel P_D in that block of pixels I_T.

With reference to FIG. 8, an operation is illustrated for de-hazing an image using de-hazing parameters. The illustrated operation assumes that the original image is an RGB image. The operation attempts to retain the color of the original RGB image as much as possible in the de-haze process. In the illustrated embodiment, the de-hazing operation converts the original image from the RGB color space to the YUV color space (Y is the luminance, U and V are the chrominance or color), and applies dehazing on the Y (luma) channel, which is generally a weighted sum of the RGB color channels.

At step 804, the video system 30 converts the RGB image to a YUV image denoted as I-YUV. The conversion of each pixel from RGB and YUV may be performed as follows:

$$[ \begin{matrix}Y \\ U \\ V\end{matrix} ] = [ \begin{matrix}0.2126 & 0.7152 & 0.0722 \\ - 0.09991 & - 0.33609 & 0.436 \\ 0.615 & - 0.55861 & - 0.05639\end{matrix} ] [ \begin{matrix}R \\ G \\ B\end{matrix} ]$$

Next, at step 806 the video system 30 performs a de-hazing operation on the channel Y (luma) of the I-YUV image. In accordance with aspects of the present disclosure, the de-hazing operation is as following:

$${Y}^{′} ( x ) = \frac{Y ( x ) - A}{T\_N ( x )} ,$$

where Y′(x) is the Y(luma) channel of de-hazed image I-Y′UV. A is the estimated atmospheric light component value determined in step 506 of FIG. 5 and in FIG. 7, and T_N(x) is the upscaled transmission map determined in step 512 of FIG. 5. Thus, the Y(luma) channel of de-hazed image I-Y′UV is equal to the difference of the Y(luma) channel of image I-YUV and the estimated atmospheric light component value A of the downscaled image calculated in step 506, divided by the transmission map T_N(x) which was created in step 512.

Finally, at step 808 the video system 30 converts the YUV dehazed image I-Y′UV to an de-hazed RGB image, where the conversion from YUV to RGB is as follows:

$$[ \begin{matrix}R \\ G \\ B\end{matrix} ] = [ \begin{matrix}1 & 0 & 1.28033 \\ 1 & - 0.21482 & - 0.38059 \\ 1 & 2.12798 & 0\end{matrix} ] [ \begin{matrix}Y \\ U \\ V\end{matrix} ]$$

In various embodiments, the video system 30 may communicate the resultant de-hazed RGB image on the display device 40 or save it to a memory or external storage device for later recall or further processing. Although the operation of FIG. 8 is described with respect to an RGB image, it will be understood that the disclosed operation can be applied to other color spaces as well.

Referring to FIG. 9, a method is illustrated for reducing flicker between successive images of a video of a surgical site. To address the possibility that a dehazed video may flicker, the brightness of dehazed videos should be stabilized. The atmospheric light component has important effects on brightness of dehazed videos, so the stability of the brightness and the flicker can be addressed by smoothing the estimated atmospheric light component between successive frames of a dehazed video. In various embodiments, low pass filtering the atmospheric light component value may be used to reduce flickering that may appear between successive frames in a de-hazed video. The operation of FIG. 9 illustrates one example of an infinite impulse response filter.

At step 902, the video system 30 initializes a previous atmospheric light component value A_PRE for a previous frame of the downscaled video. If there is no previous frame of the downscaled video, the previous atmospheric light component value A_PRE can be set to any value, such as zero.

At step 904, the video system 30 estimates the atmospheric light component value for the current frame of the downscaled video using the operation of FIG. 7.

At step 906, the video system 30 determines if the current frame of the downscaled video is the first frame of the downscaled video. If it is determined in step 906 that the current frame of the downscaled video is the first frame of the downscaled video, at step 908 the video system 30 sets the smoothed atmospheric light component value A as the estimated atmospheric light component value for the current frame of the downscaled video.

If it is determined in step 906 that the current frame of the downscaled video is not the first frame of the downscaled video, then at step 912 the video system 30 determines the smoothed atmospheric light component value as: A=A-CUR*coef+A-PRE*(1−coef), where A-CUR is the estimated atmospheric light component value for the current frame of the downscaled video, A-PRE is the estimated atmospheric light component value for a previous frame of the downscaled video, and coef is a predetermined smoothing coefficient. In various embodiments, smoothing coefficient “coef” can have a value between 0 and 1, such as 0.85.

At step 910, the video system 30 outputs the smoothed atmospheric light component value based on either step 908 or 912 accordingly. At step 914, the video system 30 replaces the previous atmospheric light component value for a previous frame of the downscaled video with the smoothed atmospheric light component value output in step 910, and proceeds to step 904 to process the next dehazed frame of the dehazed video.

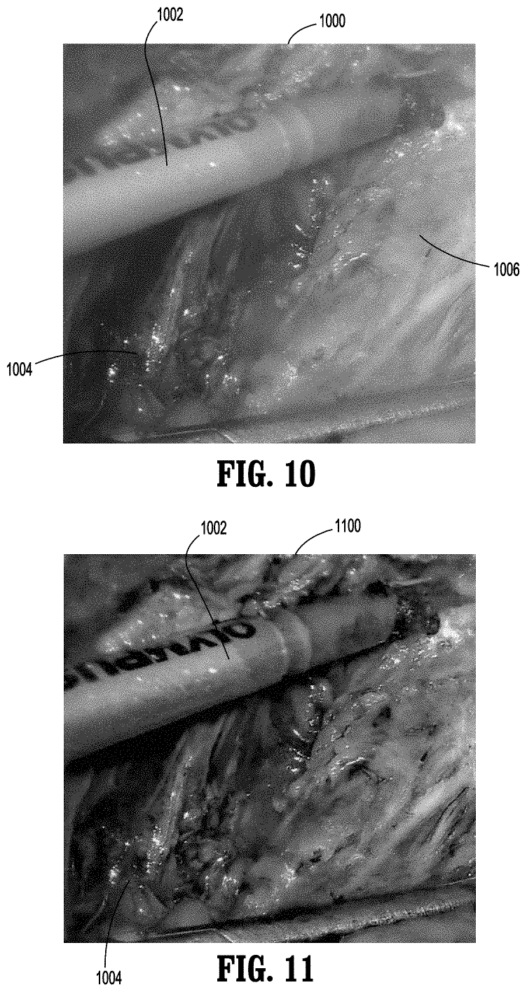

FIGS. 10 and 11 show an exemplary result of the methods described in the previous sections. FIG. 10 shows an image 1000 with smoke captured during a surgical procedure using the endoscope system 1. For example, during an endoscopic procedure, a surgeon may cut tissue 1004 with an electrosurgical instrument 1002. During this cutting haze 1006 may be generated. This haze 1006 would be captured in the image 1000.

FIG. 11 shows a de-hazed RGB image 1100, de-hazed using the method of FIGS. 5 and 8, as described herein. The de-hazed RGB image 1100 may include an electrosurgical instrument 1002 and tissue 1004.

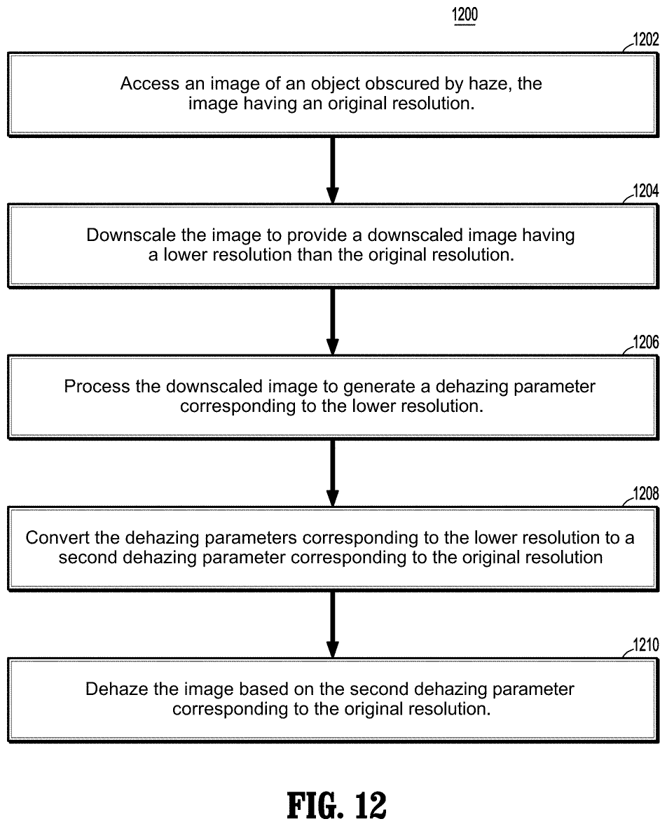

FIG. 12 shows a method for performing real-time haze reduction in accordance with the disclosure. Initially, at step 1202, an image 1000 (FIG. 10) of a surgical site is accessed by the video system 30. The image 1000 has an original resolution. For example, the original resolution may be 1080P (1920×1080 pixels).

At step 1204, the video system 30 downscales the image to provide a downscaled image having a lower resolution than the original resolution. For example, the image 1000 may be downscaled form 1920×1080 pixels to 192×108 pixels. In various embodiments, the downscaling may be performed by, super sampling, bicubic, nearest neighbor, bell, hermite, lanczos, mitchell, or bilinear downscaling.

At step 1206, the video system 30 processes the downscaled image to generate a dehazing parameter corresponding to the lower resolution. For example, the dehazing parameter may include a transmission map T, as in step 510 of FIG. 5. In various embodiments, the transmission map of the downscaled image may correspond to the size of the down scaled image.

At step 1208, the video system 30 converts the dehazing parameters corresponding to the lower resolution to second dehazing parameters corresponding to the original resolution. For example, the video system 30 may convert the transmission map T of the downscaled image to a transmission map T_N that corresponds to the original image resolution of 1920×1080 pixels.

At step 1210, video system 30 dehazes the image 1000 based on the second dehazing parameter corresponding to the original resolution. For example, the video system 30 may dehaze using any dehazing method that can utilize the transmission map T_N, resulting in a de-hazed RGB image 1100 (FIG. 11).

The embodiments disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).” The term “clinician” may refer to a clinician or any medical professional, such as a doctor, nurse, technician, medical assistant, or the like, performing a medical procedure.

The systems described herein may also utilize one or more controllers to receive various information and transform the received information to generate an output. The controller may include any type of computing device, computational circuit, or any type of processor or processing circuit capable of executing a series of instructions that are stored in a memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, causes the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

Any of the herein described methods, programs, algorithms or codes may be contained on one or more machine-readable media or memory. The term “memory” may include a mechanism that provides (for example, stores and/or transmits) information in a form readable by a machine such a processor, computer, or a digital processing device. For example, a memory may include a read only memory (ROM), random access memory (RAM), magnetic disk storage media, optical storage media, flash memory devices, or any other volatile or non-volatile memory storage device. Code or instructions contained thereon can be represented by carrier wave signals, infrared signals, digital signals, and by other like signals.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications and variances. The embodiments described with reference to the attached drawing figures are presented only to demonstrate certain examples of the present disclosure. Other elements, steps, methods, and techniques that are insubstantially different from those described above and/or in the appended claims are also intended to be within the scope of the present disclosure.

hat is claimed is:

1. A method for haze reduction in images, comprising:
accessing an image of an object obscured by haze, the image having an original resolution;
downscaling the image to provide a downscaled image having a lower resolution than the original resolution;
processing the downscaled image to generate a dehazing parameter corresponding to the lower resolution;
converting the dehazing parameter corresponding to the lower resolution to a second dehazing parameter corresponding to the original resolution; and
dehazing the image based on the second dehazing parameter corresponding to the original resolution.

2. The method of claim 1, wherein the downscaling is based on image downscaling processing and the converting is based on an inverse of the image downscaling processing, wherein the image downscaling processing is one of: super sampling, bicubic, nearest neighbor, bell, hermite, lanczos, mitchell, or bilinear downscaling.

3. The method of claim 1, wherein processing the downscaled image includes:
estimating an atmospheric light component value for the downscaled image;
determining a dark channel matrix of the downscaled image; and
determining a transmission map for the downscaled image according to the atmospheric light component and the dark channel matrix.

4. The method of claim 3, wherein converting the dehazing parameter corresponding to the lower resolution to the second dehazing parameter corresponding to the original resolution includes converting the transmission map for the downscaled image to a second transmission map for the original image.

5. The method of claim 4, wherein dehazing the image includes:
converting the image from at least one of an RGB image, a CMYK image, a CIELAB image, or a CIEXYZ image to a YUV image;
performing a de-hazing operation on the YUV image to provide a Y′UV image; and
converting the Y′UV image to the de-hazed image.

6. The method of claim 5, wherein performing the de-hazing operation on the YUV image includes, for each pixel x in the YUV image:
determining Y′ as
$${Y}^{′} ( x ) = \frac{Y ( x ) - A}{T\_N ( x )} ,$$
where:
T_N(x) is a value of the second transmission map corresponding to the pixel x, and
A is the atmospheric light component value for the downscaled image.

7. The method of claim 3, wherein determining the transmission map for the downscaled image includes determining, for each pixel x of the downscaled image:
$$T ( x ) = 1 - ω * \frac{I\_DARK ( X )}{A} ,$$
where:
ω is a predetermined constant,
I_DARK(x) is a value of the dark channel matrix for the pixel x, and
A is the atmospheric light component value.

8. The method of claim 3, wherein estimating the atmospheric light component value for the downscaled image includes, for a block of pixels in the downscaled image:
determining if a width times height for the block of pixels is greater than a predetermined threshold value,
in a case where the width times height is greater than the predetermined threshold value:
dividing the block of pixels into a plurality of smaller pixel areas,
calculating a mean value and a standard deviation for pixel values of each of the smaller pixel areas,
determining a score for each of the smaller pixel areas based on the mean value minus the standard deviation for the smaller pixel area, and
identifying one of the plurality of smaller pixel areas having a highest score among the scores; and
in a case that the width times height is not greater than the predetermined threshold value, estimating the atmospheric light component value as a darkest pixel in the block of pixels.

9. The method of claim 3, wherein estimating the atmospheric light component value includes smoothing the atmospheric light component value based on an estimated atmospheric light component value for a previous dehazed image frame.

10. The method of claim 9, wherein smoothing the atmospheric light component value includes determining the atmospheric light component value as:
A=A-CUR*coef+A-PRE*(1−coef),
where:
A-CUR is the estimated atmospheric light component value for the downscaled image,
A-PRE is the estimated atmospheric light component value for a previous downscaled image, and
coef is a predetermined smoothing coefficient.

11. A system for haze reduction in images, comprising:
an imaging device configured to capture an image of an object obscured by haze;
a display device;
a processor; and
a memory storing instructions which, when executed by the processor, cause the system to:
access the image of the object obscured by haze, the image having an original resolution,
downscale the image to provide a downscaled image having a lower resolution than the original resolution,
process the downscaled image to generate a dehazing parameter corresponding to the lower resolution,
convert the dehazing parameter corresponding to the lower resolution to a second dehazing parameter corresponding to the original resolution,
dehaze the image based on the second dehazing parameter corresponding to the original resolution, and
display the de-hazed image on the display device.

12. The system of claim 11, wherein the downscaling is based on image downscaling processing and the converting is based on an inverse of the image downscaling processing, wherein the image downscaling processing is one of: super sampling, bicubic, nearest neighbor, bell, hermite, lanczos, mitchell, or bilinear downscaling.

13. The system of claim 11, wherein in processing the downscaled image, the instructions, when executed by the processor, cause the system to:
estimate an atmospheric light component value for the downscaled image;
determine a dark channel matrix of the downscaled image; and
determine a transmission map for the downscaled image according to the atmospheric light component and the dark channel matrix.

14. The system of claim 13, wherein in converting the dehazing parameter corresponding to the lower resolution to the second dehazing parameter corresponding to the original resolution, the instructions, when executed by the processor, cause the system to convert the transmission map for the downscaled image to a second transmission map for the original image.

15. The system of claim 14, wherein in dehazing the image, the instructions, when executed by the processor, cause the system to:
convert the image from at least one of an RGB image, a CMYK image, a CIELAB image, or a CIEXYZ image to a YUV image;
perform a de-hazing operation on the YUV image to provide a Y′UV image; and
convert the Y′UV image to the de-hazed image.

16. The system of claim 15, wherein in performing the de-hazing operation on the YUV image, the instructions, when executed by the processor, cause the system to:
determine Y′ as
$${Y}^{′} ( x ) = \frac{Y ( x ) - A}{T\_N ( x )} ,$$
where:
T_N(x) is a value of the second transmission map corresponding to the pixel x, and
A is the atmospheric light component value for the downscaled image.

17. The system of claim 13, wherein in determining the transmission map for the downscaled image, the instructions, when executed by the processor, cause the system to determine, for each pixel x of the downscaled image:
$$T ( x ) = 1 - ω * \frac{I\_DARK ( X )}{A} ,$$
where:
ω is a predetermined constant,
I_DARK(x) is a value of the dark channel matrix for the pixel x, and
A is the atmospheric light component value.

18. The system of claim 13, wherein in estimating the atmospheric light component value for the downscaled image, the instructions, when executed by the processor, cause the system to, for a block of pixels in the downscaled image:
determine if a width times height for the block of pixels is greater than a predetermined threshold value,
in a case where the width times height is greater than the predetermined threshold value:
divide the block of pixels into a plurality of smaller pixel areas,
calculate a mean value and a standard deviation for pixel values of each of the smaller pixel areas,
determine a score for each of the smaller pixel areas based on the mean value minus the standard deviation for the smaller pixel area, and
identify one of the plurality of smaller pixel areas having a highest score among the scores; and
in a case that the width times height is not greater than the predetermined threshold value, estimate the atmospheric light component value as a darkest pixel in the block of pixels.

19. The system of claim 13, wherein in estimating the atmospheric light component value, the instructions, when executed by the processor, cause the system to smooth the atmospheric light component value based on an estimated atmospheric light component value for a previous dehazed image frame.

20. The system of claim 19, wherein in smoothing the atmospheric light component value, the instructions, when executed by the processor, cause the system to determine the atmospheric light component value as:
A=A-CUR*coef+A-PRE*(1−coef),
where:
A-CUR is the estimated atmospheric light component value for the downscaled image,
A-PRE is the estimated atmospheric light component value for a previous downscaled image, and coef is a predetermined smoothing coefficient.
